(19) United States
(12) Patent Application Publication
(10) Pub. No.: US 2025/0250200 A1
(43) Pub. Date: Aug. 7, 2025

(54) Sustainable Concrete Mixes Incorporating Carbon Black & Methods of Making

(71) Applicant: UNM Rainforest Innovations, Albuquerque, NM (US)

(72) Inventors: Mahmoud Reda Taha, Albuquerque, NM (US); Daniel Heras Murcia, Albuquerque, NM (US)

(73) Assignee: UNM Rainforest Innovations, Albuquerque, NM (US)

(21) Appl. No.: 18/853,114

(22) PCT Filed: Mar. 31, 2023
(86) PCT No.: PCT/US2023/017158

§ 371 Date: Sep. 30, 2024

Related U.S. Application Data
(60) Provisional application No. 63/362,335, filed on Mar. 31, 2022.

(51) Int. Cl. C04B 14/02; C04B 14/06; C04B 18/06; C04B 18/08; C04B 18/14; C04B 28/02; C04B 111/00

(52) U.S. Cl. CPC C04B 14/022; C04B 14/06; C04B 18/067; C04B 18/08; C04B 18/146; C04B 28/02; C04B 2111/00019; C04B 2111/00181; C04B 2201/50

(57) ABSTRACT

A concrete made of cement, aggregate and water, and carbon black sequestered from CO2.

### RELATED APPLICATIONS

This application is a U.S. 371 National Phase of PCT/US2023/017158, filed on Mar. 31, 2023, which claims priority to U.S. Provisional Application No. 63/362,335, filed on Mar. 31, 2023, both of which are incorporated herein in their entirety

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BRIEF SUMMARY OF THE INVENTION

In one embodiment, the present invention is to provide concrete with low carbon footprint and improved mechanical and durability properties leading pathway towards sustainable infrastructure and carbon neutrality.

In another embodiment, the present invention uses carbon black sequestered from CO2 to create concrete with superior properties and negative carbon footprint.

In another embodiment, the present invention uses carbon black sequestered from CO2 to create concrete that may be 3D printed.

In another embodiment, the present invention uses carbon black sequestered from CO2 to create concrete that may be 3D printed enabling the design and creation of complex shapes and geometries that would otherwise not be possible with traditional casting methods.

In another embodiment, the present invention provides concrete that incorporates carbon black sequestered from CO2.

In another embodiment, the present invention provides a concrete that incorporates carbon black sequestered from CO2 wherein the concrete has a low carbon footprint.

In another embodiment, the present invention provides a concrete that incorporates carbon black sequestered from CO2 wherein the concrete has improved mechanical, dimensional stability and durability properties.

In another embodiment, the present invention provides a concrete that incorporates carbon black sequestered from CO2 wherein the concrete has a negative carbon footprint.

In another embodiment, the present invention provides a concrete that incorporates carbon black sequestered from CO2 wherein the concrete may be 3D printed.

In another embodiment, the present invention provides a concrete that incorporates carbon black sequestered from CO2 wherein the concrete may be 3D printed enabling the design and creation of complex shapes and geometries that would otherwise not be possible with traditional casting methods.

In another embodiment, the present invention provides a concrete that incorporates carbon black sequestered from CO2 wherein the concrete shows a compressive strength of ˜4000 psi (30 MPa) and higher.

In another embodiment, the present invention provides a concrete that incorporates carbon black sequestered from CO2 wherein the cement/pozzolanic binder is replaced or reduced with carbon black.

In another embodiment, the present invention provides a concrete that incorporates carbon black sequestered from CO2 wherein the concrete has reduced heat storage compared with conventional concrete mixes.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 provides mixtures for various embodiments of the present invention.

FIG. 2 illustrates the carbon footprint for various concrete mixtures including various embodiments of the present invention.

FIG. 3 illustrates the carbon footprint for various concrete mixtures including various embodiments of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

In one embodiment, the present invention provides a concrete, which typically consists of at least cement, aggregate and water, that further incorporates carbon black sequestered from CO2. This embodiment of the present invention has favorable characteristics as compared with conventional concrete, such as the following: a negative carbon footprint (−0.1 to −0.3 kg CO2 eq./kg material) compared with (0.15-0.25 kg CO2 eq./kg material) for conventional concrete; excellent mechanical properties (compressive strength above 4000 psi), comparable density to normal concrete (120-130 lb./ft3) and excellent durability characteristics (chloride ion permeability of less than 1000 coulomb and spacing factor of less than 200 micrometer for freeze-thaw resistance) with low shrinkage strain (below 200 microstrains) and low creep compliance. In other embodiments, the embodiments of the present invention may have a negative carbon footprint and may be 3D printed. 3D printed enables the design and creation of complex shapes and geometries that would otherwise not be possible with traditional casting methods.

The carbon black particles tend to retain water which controls the flow properties of concrete with time. While this criteria can affect concrete thixotropy and buildability critical for 3D printing, it allows carbon black to control the characteristics of fresh and green concrete which is critical for efficient 3D printing.

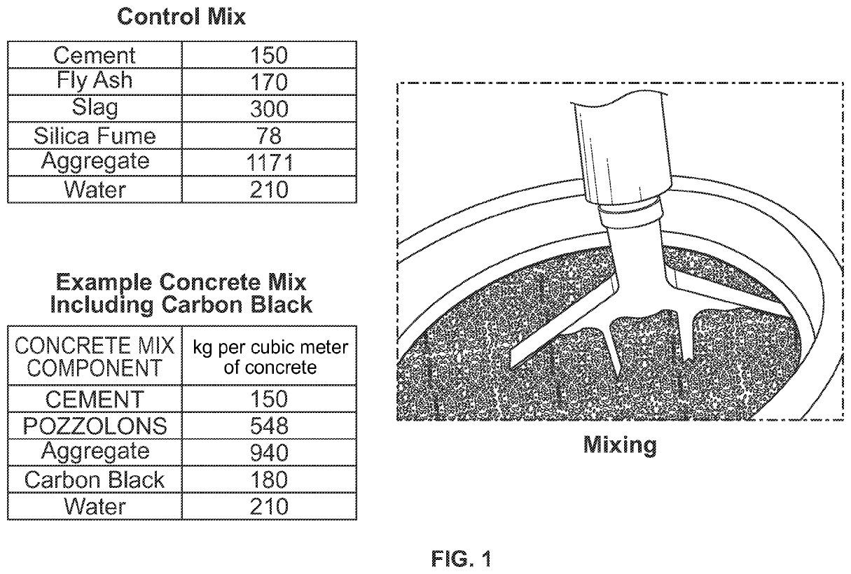

For applications with low strength requirements (e.g., sidewalks), the cement/pozzolanic binder may be replaced or reduced with carbon black. An Exemplary mixtures for various embodiments of the present invention are shown in FIG. 1.

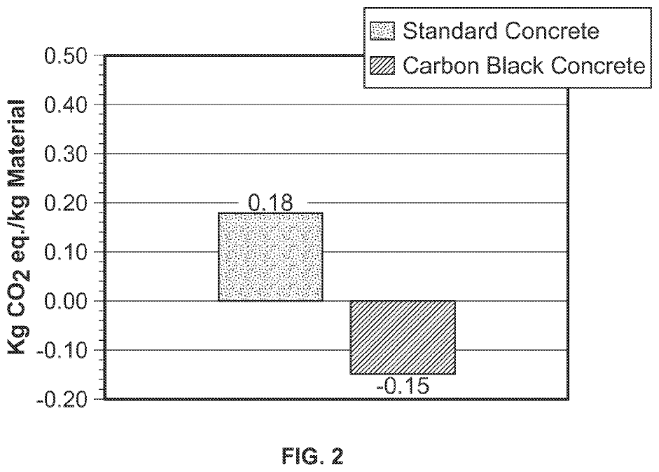

Concrete including carbon black has demonstrated low heat storage compared with conventional concrete mixes (15-20% reduction in heat storage compared with conventional cement concrete). Also, the embodiments of the present invention have a lower carbon footprint than standard concrete as shown in FIG. 2.

In one preferred embodiment, The present invention provides a concrete mixture that incorporates carbon black sequestered from CO2 wherein the mixture may be as follows:

Mixture 1

| CONCRETE MIX COMPONENT | kg per cubic meter of concrete |
|---|---|
| CEMENT | 150 |
| POZZOLONS | 548 |
| AGGREGATE | 940 |
| CARBON BLACK | 180 |
| WATER | 210 |

Mixture 2

| CONCRETE MIX COMPONENT | kg per cubic meter of concrete |
|---|---|
| CEMENT | 150 |
| FLY ASH | 170 |
| SLAG | 300 |
| SILICA FUME | 78 |
| AGGREGATE | 940 |
| CARBON BLACK | 180 |
| WATER | 210 |

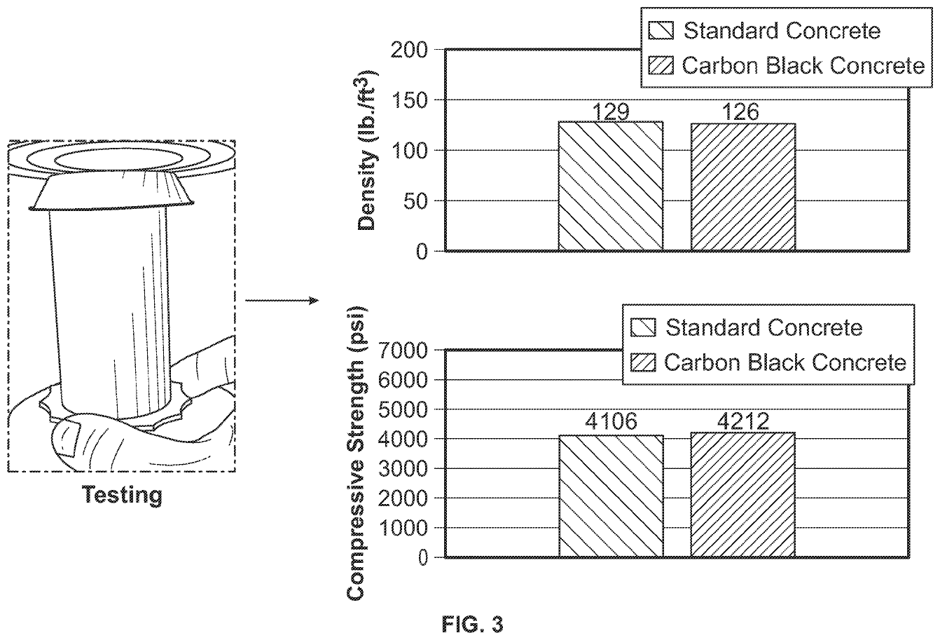

In other embodiments of the present as shown in FIG. 3, the present invention concerns concrete mixes incorporating carbon black particles that showed a density of 120-126 pounds per cubic foot and a compressive strength of ˜4000 psi (30 MPa) both of which are very suitable for concrete sidewalks.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A concrete comprising: cement, aggregate and water, and carbon black sequestered from CO2.

2. The concrete of claim 1 having a low carbon footprint.

3. The concrete of claim 1 having a negative carbon footprint.

4. The concrete of claim 1 adapted to be 3D printed.

5. A concrete that incorporates carbon black sequestered from CO2 wherein the concrete may be 3D printed enabling the design and creation of complex shapes and geometries that would otherwise not be possible with traditional casting methods.

6. A concrete comprising: cement, fly ash, slag, silica, fume, aggregate, carbon black, and water.

7. The concrete of claim 6 having a low carbon footprint.

8. The concrete of claim 6 having a negative carbon footprint.

9. The concrete of claim 6 adapted to be 3D printed.

10. The concrete of claim 8 having about 180 kg of carbon black per cubic meter of concrete.

11. The concrete of claim 10 having the following materials cement at 150 kg, pozzolans of 548 kg, aggregate at 940 kg, and water at 210 liters (kg) per one cubic meter of concrete.

12. The concrete of claim 11 having a compressive strength of ˜4000 psi (30 MPa).

13. The concrete of claim 10 having the following materials cement at 150 kg, fly ash at 170 kg, slag at 300 kg, silica fume at 78 kg, aggregate at 940 kg, and water at 210 liters (kg) per one cubic meter of concrete.
